(19) United States
(12) Patent Application Publication
(10) Pub. No.: US 2026/0261638 A1
(43) Pub. Date: Sep. 3, 2026

(54) PROJECTOR AND CONTROL METHOD THEREFOR

(71) Applicant: SAMSUNG ELECTRONICS CO., LTD., Suwon-si (KR)

(72) Inventor: Hyungchul KIM, Suwon-si (KR)

(73) Assignee: SAMSUNG ELECTRONICS CO., LTD., Suwon-si (KR)

(21) Appl. No.: 19/655,091

(22) Filed: Apr. 22, 2026

Related U.S. Application Data
(63) Continuation of application No. PCT/KR2024/015554, filed on Oct. 15, 2024.

(30) Foreign Application Priority Data
Oct. 24, 2023 (KR) 10-2023-0143189

(51) Int. Cl. H04N 9/31

(52) U.S. Cl. CPC H04N 9/3194; H04N 9/3155; H04N 9/317; H04N 9/3185

(57) ABSTRACT

A projector includes a projection unit to project an image, an illuminance sensor for sensing illuminance, an image sensor configured to capture the projected image, a memory to store a reference illuminance value, and a processor. The processor controls the projection unit to project the image onto a projection surface, adjusts the amount of light of the projection unit based on image-capture data related to the captured image obtained from the image sensor based on a sensed illuminance value of the sensed illuminance being less than the reference illuminance value, and adjusts the amount of light of the projection unit based on the sensed illuminance obtained from the illuminance sensor and the image-capture data obtained from the image sensor based on the sensed illuminance value being greater than or equal to the reference illuminance value.

### CROSS REFERENCE TO THE RELATED APPLICATION

This application is a continuation application, filed under 35 U.S.C. § 111(a), of International Application PCT/KR2024/015554 filed Oct. 15, 2024, and is based on and claims priority under 35 U.S.C. § 119 to Korean Patent Applications No. 10-2023-0143189, filed on Oct. 24, 2023, in the Korean Intellectual Property Office, the disclosures of which are incorporated by reference herein in their entireties.

### FIELD

The present disclosure relates to a projector and a control method therefor, and more particularly, to a projector that projects an image by adjusting an amount of light based on an illumination environment and a control method therefor.

### DESCRIPTION OF THE RELATED ART

With the development of electronic technology, various types of electronic devices have been developed and distributed. In particular, a projector capable of projecting an image onto a screen or a wall is used in various places such as homes, offices, and public places, and has been continuously developed in recent years.

The projector may project light generated from a light source onto a screen or a wall through a projection lens. The projector may sense external illuminance by using an illuminance sensor and adjust an amount of light based on a sensed illuminance value, thereby projecting an image to reduce unnecessary power consumption and to provide an optimal image to a user.

However, conventionally, a malfunction may often occur in the projector due to characteristics of an external illumination environment. Accordingly, a need for a technology for preventing or minimizing malfunction has emerged.

### SUMMARY

According to an embodiment of the present disclosure, a projector includes a projection unit to project an image;
an illuminance sensor configured to sense lluminance; an image sensor configured to capture the projected image; a memory to store a reference illuminance value; and a processor, wherein the processor is configured to: control the projection unit to project the image onto a projection surface; adjust an amount of light output from the projection unit based on image-capture data related to the captured image obtained from the image sensor based on a sensed illuminance value of the sensed illuminance being less than the reference illuminance value; and adjust an amount of light output from the projection unit based on the sensed illuminance obtained from the illuminance sensor and the image-capture data obtained from the image sensor based on the sense illuminance value being greater than or equal to the reference illuminance value.

The memory further stores a reference change amount and darkroom environment information, and the processor is further configured to: adjust the amount of light output from the projection unit to an amount of light corresponding to the darkroom environment information in a state in which the sensed illuminance value is less than the reference illuminance value; identify a color change amount of the image based on the image-capture data obtained from the image sensor; and increase the amount of light output from the projection unit based on the color change amount being equal to or greater than the reference change amount.

The memory further stores a reference change amount, and brightroom environment information and the processor is further configured to: adjust the amount of light output from the projection unit to an amount of light corresponding to the brightroom environment information based on the sensed illuminance value being equal to or greater than the reference illuminance value; identify a color change amount of the image based on the image-capture data obtained from the image sensor; and adjust the amount of light output from the projection unit based on the sensed illuminance obtained from the illuminance sensor based on the color change amount being within the reference change amount.

The processor is further configured to adjust the amount of light output from the projection unit based on the image-capture data obtained from the image sensor based on the color change amount being equal to or greater than the reference change amount.

The projector further includes a distance sensor configured to sense a distance from the projector to the projection surface,

The memory is further configured to store a threshold change amount, and the processor is further configured to: identify a color change amount of the image based on the image-capture data obtained from the image sensor; identify the distance to the projection surface based on the sensed distance obtained from the distance sensor based on the color change amount being equal to or greater than the threshold change amount; and adjust at least one of an image projection angle, a focal length, and a projection distance of the projection unit based on the identified distance.

The memory is further configured to store a threshold distance, and the processor is further configured to: adjust the image projection angle of the projection unit based on the identified color change amount based on the distance being less than the threshold distance, and adjust at least one of the focal length and the projection distance of the projection unit based on the identified color change amount based on the distance being equal to or greater than the threshold distance.

The memory is further configured to store a threshold change amount, and the processor is further configured to: divide the image projected onto the projection surface into a plurality of divided regions; control the image sensor to capture the image projected onto the projection surface; and identify a color change amount for each of the plurality of divided regions based on the image-capture data obtained from the image sensor; and adjust at least one of an image projection angle, a focal length, and a projection distance of the projection unit based on a distribution position of a divided region having an identified color change amount equal to or greater than the threshold change amount.

The processor is further configured to: based on the divided region having the identified color change amount being equal to or greater than the threshold change amount being positioned in an edge region of the image projected onto the projection surface, control the projection unit to adjust an image projection angle of the projection unit to project the image onto a region excluding the edge region, reduce a size of the image projected onto the region excluding the edge region; based on the divided region having the identified color change amount equal to or greater than the threshold change amount being positioned in an inner region of the image projected onto the projection surface, adjust at least one of the focal length and the projection distance of the projection unit; and based on color change amounts for all of the plurality of divided regions being equal to or greater than the threshold change amount, adjust the at least one of the focal length and and the projection distance of the projection unit.

According an embodiment of the present disclosure, a control method for a projector, the method includes projecting an image onto a projection surface; sensing illuminance by using an illuminance sensor of the projector; capturing the image projected onto the projection surface by using an image sensor of the projector; and adjusting an amount of light output from the projector based on at least one of the sensed illuminance obtained from the illuminance sensor and image-capture data related to the captured image obtained from the image sensor, wherein the adjusting of the amount of light output from the projector includes: adjusting the amount of light output from the projector based on the image-capture data obtained from the image sensor based on a sensed illuminance value of the sensed illuminance being less than a reference illuminance value, and adjusting the amount of light output from the projector based on the illuminance sensed by the illuminance sensor and the image-capture data obtained from the image sensor based on the sensed illuminance value being equal to or greater than the reference illuminance value.

The adjusting of the amount of light output from the projector based on the image-capture data obtained from the image sensor based on the sensed illuminance value being less than the reference illuminance value includes: adjusting the amount of light output from the projector to an amount of light corresponding to darkroom environment information based on the sensed illuminance value being less than the reference illuminance value; identifying a color change amount of the image based on the image-capture data obtained from the image sensor; and increasing the amount of light output from the projector based on the identified color change amount based on the color change amount being equal to or greater than a reference change amount.

The adjusting of the amount of light output from the projector based on the illuminance sensed by the lluminance sensor and the image-capture data obtained from the image sensor based on the sensed illuminance value being equal to or greater than the reference illuminance value includes: adjusting the amount of light output from the projector to an amount of light corresponding to brightroom environment information based on the sensed illuminance value being equal to or greater than the reference illuminance value; identifying a color change amount of the image based on image-capture data obtained from the image sensor; and adjusting the amount of light output from the projector based on the sensed illuminance obtained from the illuminance sensor based on the color change amount being within a reference change amount.

The adjusting of the amount of light output from the projector based on the illuminance sensed by the illuminance sensor and the image-capture data obtained from the image sensor based on the sensed illuminance value being equal to or greater than the reference illuminance value further includes adjusting the amount of light output from the projector based on the identified color change amount based on the color change amount being equal to or greater than the reference change amount.

The adjusting of the amount of light output from the projector based on the illuminance sensed by the illuminance sensor and the image-capture data obtained from the image sensor based on illuminance being equal to or greater than the reference illuminance value includes: identifying a color change amount of the image based on the image-capture data obtained from the image sensor; sensing a distance to the projection surface by using a distance sensor of the projector based on the color change amount being equal to or greater than a threshold change amount; adjusting at least one of a focal length and a projection distance of the projector based on the identified color change amount based on the sensed distance to the projection surface being equal to or greater than a threshold distance, and adjusting an image projection angle of the projector based on the identified color change amount based on the sensed distance to the projection surface being less than the threshold distance.

The method further includes dividing the image projected onto the projection surface into a plurality of divided regions; capturing the image projected onto the projection surface by using the image sensor; identifying a color change amount for each of the plurality of divided regions based on the image-capture data obtained from the image sensor; identifying a distribution position of a divided region having an identified color change amount equal to or greater than a threshold change amount based on the identified color change amount for each of the plurality of divided regions; based on the divided region having the identified color change amount equal to or greater than the threshold change amount being positioned in an edge region of the image projected onto the projection surface, controlling the projector to adjust an image projection angle to project the image onto a region excluding the edge region, or to reduce a size of the image projected onto the region excluding the edge region; based on the divided region having the identified color change amount equal to or greater than the threshold change amount being positioned in an inner region of the image projected onto the projection surface, adjusting at least one of a focal length and a projection distance of the projector; and based on color change amounts for all of the plurality of divided regions being equal to or greater than the threshold change amount, adjusting the at least one of the focal length and the projection distance of the projector.

According an embodiment of the present disclosure, a computer-readable recording medium storing a program for executing a control method for a projector, wherein the method includes: projecting an image onto a projection surface; sensing illuminance by using an illuminance sensor; capturing the image projected onto the projection surface by using an image sensor of the projector; adjusting an amount of light output from the projector based on image-capture data related to the capture image obtained from the image sensor based on a sensed illuminance value of the sensed illuminance being less than a reference illuminance value; and adjusting an amount of light output from the projector based on the illuminance sensed by the illuminance sensor and the image-capture data obtained from the image sensor based on the sensed illuminance value being equal to or greater than the reference illuminance value.

### BRIEF DESCRIPTION OF DRAWINGS

FIG. 1 is a block diagram illustrating a configuration of a projector according to various embodiments of the present disclosure.

FIG. 2 is a block diagram illustrating an example of a detailed configuration of the projector according to various embodiments.

FIGS. 3, 4 and 5 are diagrams illustrating examples of operations of the projector in various illumination environments.

FIG. 6 is a diagram illustrating an operation of the projector based on an image change.

FIGS. 7, 8, 9 10 and 11 are flowcharts illustrating a control method for a projector according to various embodiments of the present disclosure.

### DETAILED DESCRIPTION

Terms used in the specification will be briefly described, and the present disclosure will then be described in detail.

General terms currently widely used are selected as terms used in the embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. Here, the meanings of such terms are mentioned in detail in corresponding descriptions of the disclosure. Therefore, the terms used in the present disclosure need to be defined on the basis of the meanings of the terms and the contents throughout the present disclosure rather than simple names of the terms.

In the specification, the expression such as “have,” “may have,” “include,” or “may include,” indicates the presence of a corresponding feature (for example, a numerical value, a function, an operation, or a component such as a part), and does not exclude the presence of an additional feature.

In the present disclosure, the expression such as “A or B,” “least one of A and/or B,” or “one or more of A and/or B” may include all possible combinations of items enumerated together. For example, “A or B,” “at least one of A and B,” or “at least one of A or B” may indicate all of 1) a case in which at least one A is included, 2) a case in which at least one B is included, or 3) a case in which both of at least one A and at least one B are included.

The expressions such as “first” and “second,” used in the present disclosure, may indicate various components regardless of the sequence and/or importance of the components. These expressions are only used to distinguish one component and another component from each other, and do not limit the corresponding components.

When any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

A term of a singular number may include its plural number unless explicitly indicated otherwise in the context. It should be understood that a term “include” or “formed of” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “~er/~or” may perform at least one function or operation, and be implemented by hardware, software, or a combination of hardware and software. In addition, a plurality of “modules” or a plurality of “~ers/~ors” may be integrated in at least one module and be implemented by at least one processor (not shown) except for a “module” or a “~er/or” that needs to be implemented by a specific hardware.

Hereinafter, an embodiment of the present disclosure will be described in more detail with reference to the accompanying drawings.

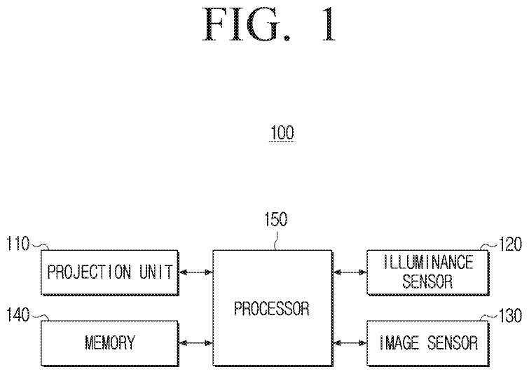

FIG. 1 is a block diagram illustrating a configuration of a projector according to various embodiments of the present disclosure.

A projector 100 refers to an electronic apparatus that represents an image by projecting light onto various projection surfaces such as a wall, a screen, a floor, or a ceiling. The projector 100 may be implemented in various forms such as a mobile projector capable of movement by including wheels, a fixed projector fixed to a ceiling or a wall, a basic projector placed on a floor, or an aerial projector usable while floating in air like a drone.

Referring to FIG. 1, the projector 100 may include a projection unit 110, an illuminance sensor 120, an image sensor 130, a memory 140, and a processor 150.

The projection unit 110 is a component for expressing an image by projecting light outward.

The projection unit 110 may project an image by using one of various projection methods such as, for example, a cathode-ray tube (CRT) method, a liquid crystal display (LCD) method, a digital light processing (DLP) method, or a laser method.

When implemented using the CRT method, the projection unit 110 may include a CRT and a lens. When an image is displayed on the CRT of the projection unit 110, light emitted from the CRT may be enlarged through the lens and projected to the outside. Based on the number of CRTs, the CRT method may be divided into a single-tube type and a three-tube type, and in the three-tube type, red, green, and blue CRTs may be separately implemented.

When implemented using the LCD method, the projection unit 110 may include a light source, a liquid crystal display (LCD), other lenses, or the like. The LCD method refers to a method of displaying an image by transmitting light emitted from the light source through the LCD. The LCD method may be divided into a single-panel type and a three-panel type. In the three-panel type, light emitted from the light source may be separated into red, green, and blue colors by a dichroic mirror (a mirror reflecting only light of a specific color and transmitting remaining light), transmitted through the LCD, and then gathered into one place again.

The DLP method refers to a method of displaying an image by using a digital micromirror device (DMD) chip. The projection unit 110 using the DLP method may include a light source, a color wheel, a DMD chip, a projection lens, or the like. Light output from the light source may be colored while passing through a rotating color wheel. Light passing through the color wheel may be input into the DMD chip. The DMD chip may include numerous micro mirrors. The DMD chip may reflect input light. The projection lens may perform a function of enlarging light reflected from the DMD chip to an image size.

In another example, the projection unit 110 using the laser method may include a diode pumped solid state (DPSS) laser and a galvanometer. To output various colors, the DPSS laser may be provided for each of RGB colors. The galvanometer may rotate a mirror at a high speed by using a motor to reflect laser light. For example, the galvanometer may rotate the mirror at the maximum of 40 KHz/sec.

According to differences in the above-described implementation methods, the projection unit 110 may include various types of light sources. For example, the projection unit 110 may include at least one light source of a lamp, a light emitting diode (LED), or a laser.

The projection unit 110 may output an image at an aspect ratio of 4:3, an aspect ratio of 5:4, or a wide aspect ratio of 16:9 based on a purpose of the projector 100 or a user setting, and may output the image having any of various resolutions such as wide video graphics array (WVGA, 854×480 pixels), super video graphics array (SVGA, 800×600 pixels), extended graphics array (XGA, 1024×768 pixels), wide extended graphics array (WXGA, 1280×720 pixels or 1280×800 pixels), super extended graphics array (SXGA, 1280×1024 pixels), ultra extended graphics array (UXGA, 1600×1200 pixels), full high-definition (full HD, 1920×1080 pixels), and ultra high-definition (UHD, 3840×2160 pixels), based on the aspect ratio.

The projection unit 110 may perform various functions to adjust an output image under control of the processor 150. For example, the projection unit 110 may perform a zoom function, a keystone function, a quick corner (four-corner) keystone function, a lens shift function, or the like.

Specifically, the projection unit 110 may perform the zoom function of enlarging or reducing an image based on a distance (projection distance) to a screen.

A method of performing the zoom function may be divided into a hardware method of adjusting a screen size by moving a lens, and a software method of adjusting a screen size by cropping an image. When the zoom function is performed, focus adjustment of an image is required. The focus adjustment may be performed by a manual focus method, an electric method, or the like. The manual focus method refers to a method of manually adjusting the focus. The electric method refers to a method of automatically adjusting the focus by using a motor. The projector 100 may selectively provide a digital zoom function or an optical zoom function.

The projection unit 110 may perform the keystone correction function. When a projection height does not match during front projection, a screen may be distorted upward or downward. The keystone correction function refers to a function of correcting a distorted screen. For example, when distortion occurs in a left-right direction of the screen, the distortion may be corrected by using horizontal keystone, and when distortion occurs in an up-down direction of the screen, the distortion may be corrected by using vertical keystone. The quick corner (four-corner) keystone correction function refers to a function of correcting a screen when a central region of the screen is normal and a corner region thereof is unbalanced. The lens shift function refers to a function of moving a screen position without distorting the screen when the screen is out of a projection range.

The projection unit 110 may automatically provide the zoom, keystone, and focus functions by analyzing a surrounding environment and a projection environment even without user manipulation. Specifically, the projection unit 110 may automatically provide the zoom, keystone, and focus functions based on information such as a distance between the projector 100 and a screen, image-capture data, information on a space in which the projector 100 is currently positioned, information on an amount of ambient light, or the like, which are sensed by sensors (e.g., a depth camera, a distance sensor, an infrared sensor, or an illuminance sensor).

In addition, the projection unit 110 may provide an illumination function by using a light source. In particular, the projection unit 110 may output light by using a light source such as one or more LEDs.

In an embodiment, the projection unit 110 may output a light source by using a surface-emitting LED. The surface-emitting LED refers to an LED having an optical sheet disposed above the LED to uniformly distribute and output light.

The projection unit 110 may provide a user with a dimming function for adjusting an intensity of light emitted from a light source. Specifically, when the user inputs a command for adjusting intensity of light emitted from a light source through various manipulation interfaces such as a touch screen, a button, or a dial, the projection unit 110 may control an LED to output light at an intensity corresponding to the user command. Alternatively, the projection unit 110 may provide the dimming function based on content analyzed by the processor 150 without a user input. Specifically, the projection unit 110 may control an LED to output intensity of light emitted from a light source based on information about currently provided content (e.g., a content type or content brightness).

The projection unit 110 may control a color temperature under control of the processor 150.

The illuminance sensor 120 is a component for sensing surrounding illuminance of the projector 100. The illuminance sensor 120 may measure intensity of light by using a photoelectric effect. The photoelectric effect refers to a phenomenon in which electrons are generated by light energy and a current flows when light having a frequency equal to or greater than a specific frequency is input to a metal.

The processor 150 may identify the surrounding illuminance of the projector 100 based on a sensing value obtained from the illuminance sensor 120, and may adjust an amount of light output from the projector 100 based on the identified illuminance. Specifically, when the identified illuminance is high and equal to or greater than a predetermined value, that is, in a bright place, the processor 150 may increase intensity of an amount of light for projecting an image, and when the identified illuminance is low and less than the predetermined value, that is, in a dark place, the processor 150 may decrease intensity of an amount of light for projecting an image, thereby reducing power consumption of a battery. Based on a threshold set for illuminance, the processor 150 may stepwise adjust an intensity of light by distinguishing between a case in which the surrounding illuminance is equal to or greater than the threshold and a case in which the surrounding illuminance is less than the threshold. However, the present disclosure is not limited thereto, and such determination may be made based on various criteria.

For example, the processor 150 may distinguish the surrounding illuminance into a plurality of levels and may adjust an amount of light output from the projection unit 110 to a predetermined intensity for each level.

Alternatively, the processor 150 may adjust the amount of light output from the projection unit 110 to an intensity that adaptively corresponds to the surrounding illuminance.

When the surrounding illuminance is equal to or greater than the maximum threshold, the processor 150 may control the projection unit 110 to maintain an amount of light at the maximum value or to stop image projection. In addition, when the surrounding illuminance is less than the minimum threshold, the processor 150 may control the projection unit 110 to maintain an amount of light at the minimum value.

The image sensor 130 is a component for capturing an image. The image sensor 130 may capture images of various external objects including a projection surface under control of the processor 150. For example, the image sensor 130 included in a camera may convert an image captured through a camera lens into a digital signal and generate image data based on the converted signal. The image sensor 130 may be classified as a complementary metal oxide semiconductor (CMOS) image sensor or a charge coupled device (CCD) image sensor based on a structure. The processor 150 may identify brightness of an image based on image data, that is, image-capture data obtained from the image sensor 130.

The memory 140 may store at least one instruction, data, program, or the like required for an operation of the projector 100. For example, the memory 140 may store a reference illuminance value. The reference illuminance value indicates an illuminance value for the processor 150 to determine whether an external illumination environment of the projector 100 is a darkroom environment or a brightroom environment. For example, when the reference illuminance value is stored as 50 lux in the memory 140, the processor 150 may determine the external illumination environment as the darkroom environment when illuminance is less than 50 lux, and may determine the external illumination environment as the brightroom environment when illuminance is equal to or greater than 50 lux.

The memory 140 may be implemented in a form of a memory embedded in the projector 100 or in a form of a memory detachably attached to the projector 100 based on a data storage purpose. For example, data for driving the projector 100 may be stored in the embedded memory of the projector 100, and data for extension functions of the projector 100 may be stored in the memory detachably attached to the projector 100.

The embedded memory of the projector 100 may be implemented as at least one of a volatile memory (e.g., a dynamic random access memory (DRAM), a static random access memory (SRAM), or a synchronous dynamic random access memory (SDRAM)) or a non-volatile memory (e.g., a one time programmable read-only memory (OTPROM), a programmable read-only memory (PROM), an erasable and programmable read-only memory (EPROM), an electrically erasable and programmable read-only memory (EEPROM), a mask ROM, a flash ROM, a flash memory (e.g., a NAND flash or a NOR flash), a hard drive, or a solid state drive (SSD)).

The memory 140 may be implemented as a single memory storing data generated in various operations according to the present disclosure, is not limited thereto, and may be implemented to include a plurality of memories each storing different types of data or data generated in different stages.

The processor 150 is a component connected to each component of the projector 100 to control an overall operation of the projector 100. The processor 150 may be implemented as a digital signal processor (DSP), a microprocessor, a graphics processing unit (GPU), an artificial intelligence (AI) processor, a neural processing unit (NPU), or a time controller (TCON) for processing a digital image signal. However, the processor 150 is not limited thereto, and may include or be defined as one or more of a central processing unit (CPU), a micro controller unit (MCU), a micro processing unit (MPU), a controller, an application processor (AP), a communication processor (CP), or an advanced reduced instruction set computer (RISC) machines (ARM) processor. In addition, the processor 150 may be implemented as system-on-chip (SoC) or a large scale integration (LSI) in which a processing algorithm is embedded, or may be implemented in a form of an application-specific integrated circuit (ASIC) or a field programmable gate array (FPGA).

In addition, the processor 150 for executing an artificial intelligence model according to an embodiment may be implemented based on a combination of software and a general-purpose processor such as a CPU, an AP, or digital signal processor (DSP), a graphics-dedicated processor such as a GPU or a vision processing unit (VPU), or an artificial intelligence-dedicated processor such as an NPU.

The processor 150 may control processing of input data according to predefined operation rules or an artificial intelligence model stored in the memory. Alternatively, when the processor 150 is a dedicated processor (or the artificial intelligence-dedicated processor), the processor 150 may be designed to have a hardware structure specialized for processing a specific artificial intelligence model. For example, hardware specialized for processing a specific artificial intelligence model may be designed as a hardware chip such as an ASIC or an FPGA.

When the processor 150 is implemented as a dedicated processor, the processor 150 may be implemented to include a memory for implementing an embodiment of the present disclosure, or to include a memory processing function for using an external memory. The processor 150 may be implemented as one or more processors.

The processor 150 may control the projection unit 110 to project an image onto the projection surface. The processor 150 may adjust the amount of light output from the projection unit 110 based on at least one of a sensing result obtained from the illuminance sensor 120 or the image-capture data obtained from the image sensor 130. For example, the processor 150 may adjust the amount of light output from the projection unit 110 based on the image-capture data obtained from the image sensor 130 when illuminance is less than the reference illuminance value. In addition, the processor 150 may adjust the amount of light output from the projection unit 110 based on the sensing result obtained from the illuminance sensor 120 and the image-capture data obtained from the image sensor 130 when illuminance is equal to or greater than the reference illuminance value.

As described above, in the related art in which an amount of light is adjusted only based on the sensing value obtained from the illuminance sensor 120, when an image projected by the projector suddenly becomes bright (e.g., an image that suddenly changes from night to day or an image in which lightning strikes), the sensing value obtained from the illuminance sensor may be momentarily measured to be high due to brightness of the image. In an environment in which the surrounding illuminance is high to some extent (e.g., the brightroom environment), such malfunction does not frequently occur. However, in an environment in which the surrounding illuminance is low (e.g., the darkroom environment), a possibility that such malfunction occurs may increase. According to the present disclosure, when the surrounding illuminance is less than the reference illuminance value, the amount of light output from the projection unit 110 may be adjusted based on the image-capture data obtained from the image sensor 130, thereby preventing occurrence of such malfunction.

In addition, when the surrounding illuminance is equal to or greater than the reference illuminance value, the processor 150 may determine whether to adjust an amount of light by considering both the sensing result obtained from the illuminance sensor 120 and the image-capture data obtained from the image sensor 130. Accordingly, more precise adjustment of an amount of light may become possible.

A method of adjusting an amount of light may vary depending on a type of the projector 100 described above. For example, in a projector using the cathode-ray tube (CRT) method, the processor 150 may adjust an amount of light by adjusting luminance of a cathode-ray tube included in the projection unit 110. Alternatively, in a projector using a liquid crystal display (LCD) method or a digital light processing (DLP) method, the processor 150 may adjust an amount of light by adjusting intensity of a current or a voltage applied to a backlight unit, that is, a light source included in the projection unit 110. Alternatively, in a projector 100 using the laser method, the processor 150 may adjust an amount of light by adjusting intensity of a current or a voltage applied to a laser scanning unit. Alternatively, in a projector 100 including a display that includes self-emitting elements, the processor 150 may adjust an amount of light by adjusting a magnitude of a current or a voltage applied to each light-emitting element line from a driver integrated circuit (IC) included in the display.

A detailed method of adjusting the amount of light output from the projection unit 110 based on illuminance, which is performed by the processor 150, is further described below.

Referring to FIG. 1, a case in which the projector 100 includes basic components for sensing illuminance, capturing an image projected onto the projection surface, and adjusting the amount of light output from the projection unit 110 based on a sensing result for illuminance and the image-capture data is illustrated and described as a reference. However, according to various embodiments of the present disclosure, the projector 100 may further include additional components for identifying the image projected onto the projection surface in various manners and adjusting the amount of light output from the projection unit 110.

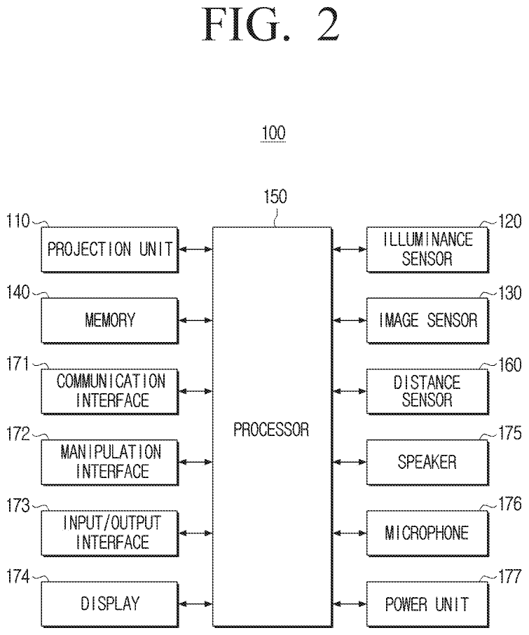

FIG. 2 is a block diagram illustrating an example of a detailed configuration of the projector according to the various embodiments.

Referring to FIG. 2, the projector 100 may further include a distance sensor 160, a communication interface 171, a manipulation interface 172, an input/output interface 173, a display 174, a speaker 175, a microphone 176, and a power unit 177, in addition to the projection unit 110, the illuminance sensor 120, the image sensor 130, the memory 140, and the processor 150. However, the present disclosure is not limited thereto, and the projector 100 may further include other components, or some of the components may be omitted or modified. In descriptions of the projection unit 110, the illuminance sensor 120, the image sensor 130, the memory 140, and the processor 150 in the configuration of FIG. 2, redundant descriptions of parts identical to those described with reference to FIG. 1 are omitted.

The distance sensor 160 is a component for sensing a distance to an external object. The processor 150 may identify a distance to a projection surface or another external object based on a sensing value obtained from the distance sensor 160. The distance sensor 160 may include at least one of an ultrasonic sensor, an infrared sensor, a laser sensor, an optical distance sensor, a radar (RADAR) sensor, a light detection and ranging (LIDAR) sensor, a photodiode sensor, or a time of flight (ToF) sensor.

For example, when implemented as the ultrasonic sensor, the distance sensor 160 may include a transmitter and a receiver. When a sound wave is output from the transmitter, the receiver may receive an echo of the output sound wave reflected from an object. The processor 150 may calculate a distance to the object based on a time difference between the output time and reception time of the sound wave based on a speed of sound (340 m/s).

When implemented as the infrared sensor, the distance sensor 160 may include a light emitter and a light receiver. When infrared light is output from the light emitter, output infrared light may collide with an object and be reflected. The light receiver may detect a reflected incoming signal. The infrared sensor may use light rather than a sound wave, and accordingly, a distance to an object may be measured by calculating an angle relative to a focus formed on the object based on optical triangulation.

In addition, the TOF sensor refers to a sensor for measuring a distance to an object by using signals such as near-infrared light, ultrasonic waves, or lasers. The TOF sensor may include a transmitter for outputting various signals and a receiver for receiving a reflected signal corresponding thereto. The TOF sensor may measure a distance between the projector 100, i.e., an apparatus including the sensor, and an object based on a time (time of flight) during which a signal emitted from the transmitter is reflected from the object and returns. The object may correspond to the projection surface onto which the projector 100 projects an image. The projection surface may be implemented as a white screen. However, the present disclosure is not limited thereto, and various wall surfaces, one surface of an object, or the like may also be used as the projection surface.

As described above, when the projector 100 is implemented as a mobile projector which is movable, the processor 150 may project an image by defining a wall surface, one surface of furniture, one surface of a home appliance, or the like as the projection surface in an environment (e.g., in a home) in which the projector 100 is placed. In this case, the processor 150 may identify a distance to the projection surface based on a sensing value obtained from the distance sensor 160 and may control a driving unit (not shown) to be spaced apart from the projection surface by an appropriate distance in consideration of the size, resolution, or the like of an image to be displayed.

Alternatively, when the projector 100 is implemented as a general projector that does not have a driving function, the user may determine the position and projection direction of the projector 100 by lifting and moving the projector 100. When the projector 100 is turned on, the processor 150 may identify the distance to the projection surface located in front of the projection direction of the projector 100 based on the sensing value obtained from the distance sensor 160, scale an image to the size, resolution, or the like corresponding to the distance, and control the projection unit 110 to project the image.

In addition, the processor 150 may adjust the focal length, projection distance, image projection angle, or the like of the projection unit 110 based on identified distance information.

The communication interface 171 is a component for performing communication with at least one external device. The communication interface 171 may include at least one wireless communication module or at least one wired communication module. Each communication module may be implemented in a form of at least one hardware chip. For example, the wireless communication module may include at least one of a wireless fidelity (Wi-Fi) module, a Bluetooth module, an infrared communication module, or another communication module. In addition, the communication interface 171 may include at least one communication chip for performing communication according to various wireless communication standards such as Zigbee, third generation (3G), third generation partnership project (3GPP), long term evolution (LTE), LTE advanced (LTE-A), fourth generation (4G), and fifth generation (5G).

For example, the wired communication module may include at least one of a local area network (LAN) module, an Ethernet module, a pair cable, a coaxial cable, an optical fiber cable, or an ultrawideband (UWB) module. The projector 100 may perform various operations such as demultiplexing, deinterleaving, decoding, scaling, and filtering on content data provided from an external source (e.g., a web server, a broadcasting station, or a multimedia playback apparatus) connected thereto through the communication interface 171 to configure an image, and may project the configured image onto the projection surface through the projection unit 110.

The manipulation interface 172 is a component for receiving a user manipulation. The manipulation interface 172 may include various buttons, a touch screen, or the like included in a main body of the projector 100.

The input/output interface 173 is a component for inputting and outputting various external signals. The input/output interface 173 may receive at least one of an audio signal or an image signal from various content sources (e.g., a web server, a media player, or a user terminal device). Alternatively, the input/output interface 173 may transmit and receive data, a control signal, or the like to and from various external devices (e.g., another projector, a remote controller, a mobile phone, a speaker, a television (TV), or illumination).

The input/output interface 173 may be implemented as at least one wired input/output interface among a high-definition multimedia interface (HDMI), a mobile high-definition link (MHL), a universal serial bus (USB), a universal serial bus type-C (USB Type-C), a display port (DP), a thunderbolt interface (Thunderbolt), a video graphics array (VGA) port, a red-green-blue (RGB) port, a d-subminiature (D-SUB), and a digital visual interface (DVI). Although FIG. 2 illustrates the input/output interface 173 and the communication interface 171 as separate components, when communication is performed with an external device through the input/output interface 173, the input/output interface 173 may be regarded as a component included in the communication interface 171.

The display 174 is a component for displaying an operation state of the projector 100, a notification message, a user interface (UI) screen, or the like. The display 174 may be implemented as various types of displays such as a liquid crystal display (LCD) and an organic light emitting diode (OLED) display. Alternatively, the display 174 may be implemented using only one light-emitting element or a plurality of light-emitting elements. The processor 150 may change a display state of the display 174 based on various states including a turned-on state of the projector 100, a normal operation state of the projector 100, or a state in which power is insufficient or an error state occurs, thereby allowing the user to intuitively recognize a state of the projector 100.

The speaker 175 is a component for outputting an audio signal. Although only the speaker 175 is illustrated in FIG. 2, various components such as an audio decoder, an audio output mixer, an audio signal processor, and an amplification circuit for processing the audio signal may be further included in the projector 100. The speaker 175 may include one or more speakers, and when implemented as a plurality of speakers, the speakers may be symmetrically arranged on an exterior of the main body to output the audio signal in all directions, that is, in 360-degree directions.

The microphone 176 is a component for receiving various audio signals. The microphone 176 may receive a user voice or another sound and convert the received sound into audio data. The microphone 176 may be integrally formed on the upper portion, a front portion, a side portion, or the like of the projector 100. The projector 100 may include various components such as an amplifier circuit for amplifying an audio signal received through the microphone 176, an analog to digital (A/D) conversion circuit for sampling the amplified audio signal and converting the sampled audio signal into a digital signal, and a filter circuit for removing a noise component from the converted digital signal.

The power unit 177 may receive power from an external source and supply power to various components of the projector 100. The power unit 177 may receive power through various methods. For example, when a charging station (not shown) for charging is provided in an environment in which the projector 100 operates, the power unit 177 may receive power through the charging station. Alternatively, the power unit 177 may receive power from an external device or a power source by various wired or wireless charging methods. Alternatively, the power unit 177 may include a battery. When external power is connected thereto, the power unit 177 may charge the battery and use power of the battery by using an electrical signal applied from the external power. Alternatively, the power unit 177 may be implemented to include a replaceable battery mounted therein.

Although not illustrated in FIG. 2, when the projector 100 is implemented as a mobile type, the projector 100 may further include the driving unit including at least one motor, a plurality of wheels, and at least one shaft and a gear for transmitting a force from the motor to the plurality of wheels, or the like.

As described above, the projector 100 may include various components based on a type thereof. Accordingly, the projector 100 may project an image onto various types of projection surfaces, and may project an image by adjusting the amount of light output from the projection unit 110 based on various external illumination environments.

Meanwhile, even when the sensing result for illuminance is sensed and the illuminance value corresponding to the brightroom environment or the darkroom environment is sensed, a color of the image projected onto the projection surface may change because the image is influenced by illumination.

Hereinafter, various external illumination environments for the projector 100 to project an image onto the projection surface is first described in detail.

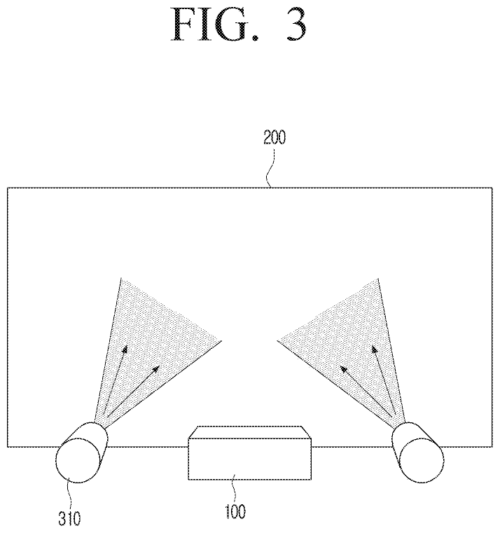

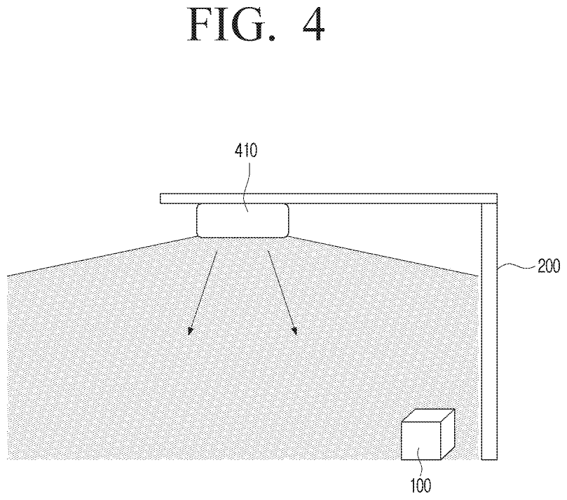

FIGS. 3, 4 and 5 are diagrams illustrating examples of operations of the projector in various illumination environments. FIG. 3 illustrates an environment in which two external illuminations 310 are used. The external illumination 310 may be implemented in various forms such as not only an illumination device such as a stand, a lamp, an illumination lamp, and a flash, but also various electronic apparatuses such as a light emitting television (TV) or a monitor, a window, a door, and a candle. External illuminations described in other drawings below may also be implemented in various forms as described above.

FIG. 3 illustrates a case in which the external illumination 310 faces a projection surface 200. In this case, the illuminance sensor 120 may sense reflected light reflected from the projection surface rather than directly sensing illuminance emitted from the illumination. In addition, an image projected onto the projection surface may be viewed as having a different color by the user due to an influence from illumination.

In this case, the processor 150 may determine whether illuminance is less than the reference illuminance value based on a sensing result obtained from the illuminance sensor 120. The processor 150 may adjust the amount of light output from the projection unit 110 to an amount of light corresponding to the darkroom environment in a state in which illuminance is less than the reference illuminance value. As illustrated in FIG. 3, the external illumination 310 may be disposed around the projector 100, and accordingly, an actual illumination environment does not correspond to a darkroom environment state. However, the illuminance sensor 120 may not directly sense illuminance of the illumination, and accordingly, the sensing value obtained from the illuminance sensor 120 may be less than the reference illuminance value. In such a state, the processor 150 may adjust the amount of light output from the projection unit 110 to an amount of light corresponding to the darkroom environment.

The processor 150 may set the amount of light corresponding to the darkroom environment based on a maximum light output projected from the projection unit 110. Information about an amount of light corresponding to each environment may be stored in the memory 140. For example, the processor 150 may set the amount of light corresponding to the darkroom environment to an amount of light of 50% of the maximum light output of the projection unit 110 and may set an amount of light corresponding to the brightroom environment to an amount of light of 80% of the maximum light output of the projection unit 110, and may store the amount of light corresponding to the darkroom environment and the amount of light corresponding to the brightroom environment in the memory 140.

The processor 150 may identify a color change amount of the image based on the image-capture data obtained from the image sensor 130, and may increase the amount of light output from the projection unit 110 when the color change amount is equal to or greater than a reference change amount. Specifically, when the color change amount is equal to or greater than the reference change amount, the processor 150 may control the projection unit 110 to increase an amount of light in proportion to the difference. When the amount of light increases, an original color of the image becomes more recognizable to the user.

For example, the processor 150 may divide an image captured using the image sensor 130 into a plurality of blocks and extract RGB color values of a plurality of pixels included in each block. The processor 150 may calculate an average value of the RGB color values of the pixels included in each block. The processor 150 may also calculate an average value of RGB color values for each block in the same manner with respect to image data stored in the memory 140. The processor 150 may calculate a difference value by comparing the average values of the respective blocks. The calculated difference value may correspond to the color change amount, that is, a difference between an actual color of an image projected from the projection unit 110 and a color changed due to the external illumination 310. The processor 150 may compare the color change amount calculated in such a manner with the reference change amount pre-stored in the memory 140. The reference change amount may correspond to a difference value obtained by comparing an actual RGB value for each pixel of the image and an RGB value recognized under a predetermined reference illumination. Information about the reference change amount or the like may be predetermined and stored in the memory 140.

According to the above-described method, even when a color of an image changes due to the external illumination 310 that is not sensed by the illuminance sensor 120 as illustrated in FIG. 3, image quality may be improved by adjusting the amount of light output from the projection unit 110.

In addition, when the processor 150 determines that the color change amount is within the reference change amount, the processor 150 may determine an illumination environment as corresponding to an actual darkroom environment state and may control the projection unit 110 to maintain the amount of light corresponding to the darkroom environment.

FIG. 4 illustrates a case in which an illumination environment of the projector 100 corresponds to an overall illumination state. Referring to FIG. 4, an external illumination 410 may be projected toward the projector 100 and the projection surface 200 in an overall manner, and accordingly, the illuminance sensor 120 may sense illuminance from illumination influencing an image projected onto the projection surface. In addition, in FIG. 4, the external illumination 410 may not directly project strong light toward the projection surface 200, and accordingly, an influence on a color change of the image may become relatively small.

In this case, the processor 150 may adjust the amount of light output from the projection unit 110 to the amount of light corresponding to the brightroom environment when illuminance is equal to or greater than the reference illuminance value. In addition, the processor 150 may identify the color change amount of the image based on the image-capture data obtained from the image sensor 130, and the processor 150 may adjust the amount of light output from the projection unit 110 based on the sensing result obtained from the illuminance sensor 120 when the color change amount is within the reference change amount. A method of identifying the color change amount, a method of comparing the color change amount with the reference change amount, a method of adjusting an amount of light, and the like are described in the above-described descriptions, and redundant descriptions thereof are thus omitted.

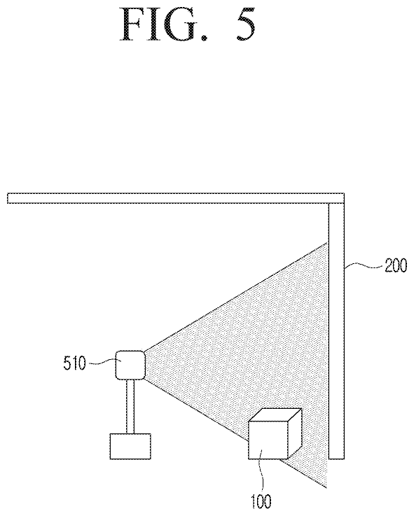

FIG. 5 illustrates a case in which an external illumination 510 is strongly projected toward the projector 100 and the projection surface 200. Referring to FIG. 5, the external illumination 510 may be projected toward the projector 100 and the projection surface 200, and accordingly, the illuminance sensor 120 may sense illuminance from the external illumination 510. However, an influence on a color change of the image may be relatively large because the external illumination 510 is strongly projected toward the projection surface 200.

In this case, the processor 150 may adjust the amount of light output from the projection unit 110 to the amount of light corresponding to the brightroom environment when illuminance is equal to or greater than the reference illuminance value, identify the color change amount of the image based on the image-capture data obtained from the image sensor 130, and the processor 150 may adjust the amount of light output from the projection unit 110 based on the image-capture data obtained from the image sensor 130 when the color change amount is equal to or greater than the reference change amount.

When the identified color change amount is equal to or greater than a threshold change amount, the processor 150 may sense the distance to the projection surface by using the distance sensor 160. The threshold change amount indicates a limit value of the color change amount within which the color change amount of the image may be reduced to be within the reference change amount by adjusting the amount of light output from the projection unit 110. When the identified color change amount is within the threshold change amount, the processor 150 may reduce the color change amount to be within the reference change amount by adjusting the amount of light output from the projection unit 110.

However, when the identified color change amount is out of the threshold change amount, the processor 150 is unable to reduce the color change amount to be within the reference change amount only by using the method of adjusting the amount of light output from the projection unit 110.

In this case, the processor 150 may identify the distance to the projection surface based on the sensing result obtained from the distance sensor 160, and may adjust at least one of the image projection angle, focal length, or projection distance of the projection unit 110 based on the identified distance.

The processor 150 may adjust the image projection angle of the projection unit 110 based on the identified color change amount when the identified distance is less than a predetermined threshold distance. When the color change amount of the image is reduced to be within the threshold change amount by adjusting the image projection angle, the processor 150 may re-identify the reduced color change amount based on the image-capture data obtained from the image sensor 130, and may reduce the color change amount to be within the reference change amount by adjusting the amount of light output from the projection unit 110 based on the reduced color change amount.

The processor 150 may adjust at least one of the focal length or projection distance of the projection unit 110 based on the identified color change amount when the identified distance is equal to or greater than the predetermined threshold distance. The processor 150 may reduce the distance between the projection unit 100 and the projection surface by adjusting at least one of the focal length or the projection distance.

Alternatively, the processor 150 may output a notification message through the display 174 or may output a voice guidance message through the speaker 175 to adjust the distance between the projector 100 and the projection surface.

When the distance between the projector 100 and the projection surface is reduced to reduce the color change amount of the image to be within the threshold change amount, the processor 150 may reduce the color change amount to be within the reference change amount by adjusting the amount of light output from the projection unit 110 based on the color change amount reduced to be within a threshold change amount.

The processor 150 may divide the image projected onto the projection surface into a plurality of divided regions, and control the image sensor 130 to capture the image projected onto the projection surface. In this case, the processor 150 may generate coordinate information based on the image projected onto the projection surface and may distinguish the divided regions of the image projected onto the projection surface based on the generated coordinate information.

In addition, the processor 150 may identify a color change amount for each of the plurality of divided regions based on the image-capture data obtained from the image sensor 130, and may adjust at least one of the image projection angle, focal length, or projection distance of the projection unit 110 based on a distribution position of a divided region having an identified color change amount equal to or greater than the threshold change amount.

For example, the processor 150 may control the projection unit 110 to adjust the image projection angle to project the image onto a region excluding an edge region, or to reduce a size of the image when the divided region having the identified color change amount equal to or greater than the threshold change amount is positioned in the edge region of the image projected onto the projection surface.

Next, the processor 150 may re-identify a color change amount of an image having the reduced size based on the image-capture data obtained from the image sensor 130, and may adjust the amount of light output from the projection unit 110 based on the identified color change amount.

The processor 150 may adjust at least one of the focal length or projection distance of the projection unit 110 when the divided region having the identified color change amount equal to or greater than the threshold change amount is positioned in an inner region of the image projected onto the projection surface, or when color change amounts for all of the plurality of divided regions are equal to or greater than the threshold change amount. In this case, the processor may output the notification message through the display 174 or may output the voice guidance message through the speaker 175.

Next, after adjusting the distance between the projector 100 and the projection surface, the processor 150 may re-identify the color change amount of the image based on the image-capture data obtained from the image sensor 130. When the divided region having the color change amount equal to or greater than the threshold change amount is not detected based on the re-identified color change amount, the processor 150 may reduce the color change amount to be within the reference change amount by adjusting the amount of light output from the projection unit 110.

Meanwhile, when the projector 100 projects an image in the darkroom environment having no particular illumination, the projector 100 may be influenced by instantaneous change of the image. For example, a scene may suddenly change from a dark night scene to a day scene, or a scene in which lightning strikes may be displayed.

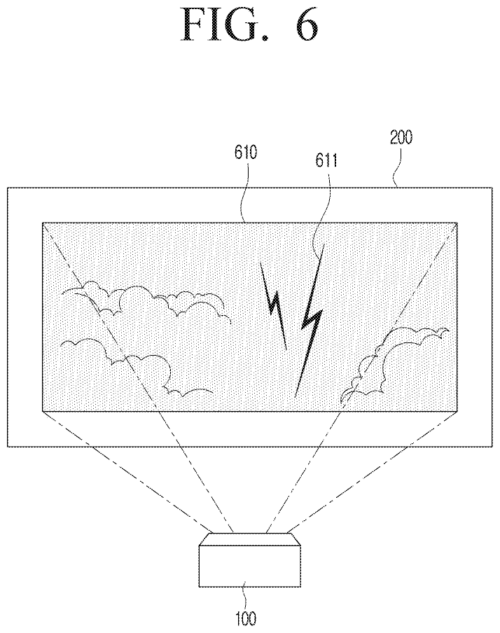

FIG. 6 is a diagram illustrating an operation of the projector based on an image change. FIG. 6 illustrates an example of a case in which an image is projected in the darkroom environment in which there is no external illumination directly projected to the projector 100 and the projection surface 200.

Referring to FIG. 6, a case is illustrated in which lightning 611 is displayed in a state in which the projector 100 projects an image 610 representing a night sky onto the projection surface 200. When illuminance sensed by the illuminance sensor 120 is less than the reference illuminance value, the processor 150 may recognize the illuminance as corresponding to the darkroom environment. In the darkroom environment, the processor 150 may determine whether to adjust an amount of light based on the image-capture data obtained from the image sensor 130, rather than the sensing value obtained from the illuminance sensor 120.

In the case illustrated in FIG. 6, the processor 150 may analyze the captured image obtained from the image sensor 130 on a pixel-by-pixel basis or on a pixel block basis, and may identify the RGB value of each pixel. The processor 150 may identify the RGB value of each pixel included in an original image and compare the identified RGB value with an identified value for the captured image. As a result of the comparison, when characteristics of an RGB value of a pixel or a pixel block corresponding to a region of lightning 611 are identical to each other, or when the color change amount is within the reference change amount, the processor 150 may recognize that an image frame is changed and may not adjust the amount of light output from the projection unit 110. Accordingly, malfunction that often occurs in the related art projector may be prevented.

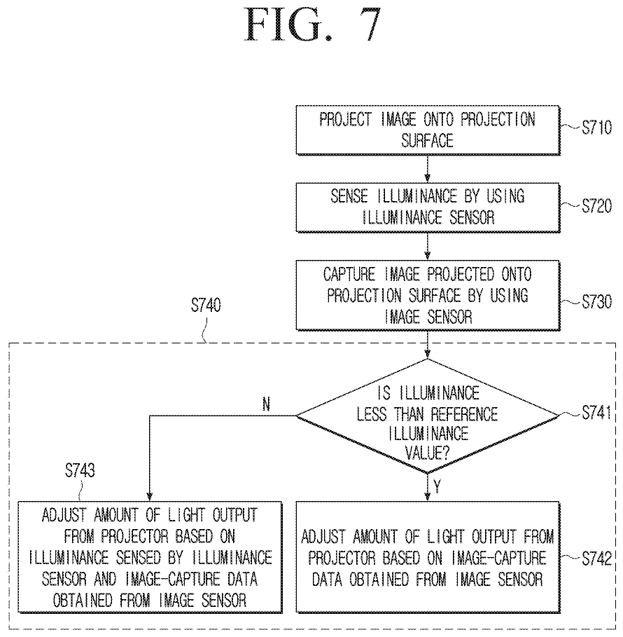

FIGS. 7, 8, 9, 10, and 11 are flowcharts illustrating a control method for a projector according to various embodiments of the present disclosure.

Referring to FIG. 7, the projector may project the image onto the projection surface (S710). In addition, the projector may sense the surrounding illuminance of the projector by using the illuminance sensor (S720).

In the case of a television (TV) or a terminal monitor, colors of a displayed image do not change even when the external illumination environment is changed. However, the projector may be greatly influenced by the external illumination because the projector projects an image onto the projection surface and the user recognizes the image based on light reflected from the projection surface.

For example, as an intensity of light having a specific color increases in external illumination projected onto the projection surface, the projector may project the image projected onto the projection surface that is more greatly influenced by the specific color, and the image may become an image closer to the specific color. In addition, when external illumination outputs light including a plurality of colors having the same intensity, the plurality of color lights may be mixed with each other, and accordingly, the image projected onto the projection surface may become an image close to white.

Even when external illumination disposed around the projector outputs light having the same intensity, an illuminance value sensed by the projector may vary depending on the position and direction of the external illumination.

As described above, when the external illumination outputs light while having a direction limited to the projection surface, the image projected onto the projection surface may change in color due to an influence from the external illumination although the projector does not sense illuminance.

In addition, when the external illumination outputs light while being limited to the projector and not facing the projection surface, the projector may sense illuminance from the external illumination and increase an amount of light output from the projector. However, the external illumination does not influence the image projected onto the projection surface, thereby causing unnecessary power consumption.

In this case, the projector may store, in the memory, the reference illuminance value for determining whether the surrounding illuminance is the darkroom environment or the brightroom environment.

The projector may capture the image projected onto the projection surface by using the image sensor (S730). The projector may capture the image by using the image sensor and may compare the original image data stored in the memory with the image-capture data. Accordingly, when the external illumination influences the image projected onto the projection surface although the projector does not recognize illuminance from the external illumination, the projector may adjust an amount of light output from the projector based on the image-capture data obtained from the image sensor.

The projector may adjust an amount of light output from the projector based on at least one of the sensing value obtained from the illuminance sensor or the image-capture data obtained from the image sensor (S740).

First, the projector may determine whether illuminance is less than the reference illuminance value based on the sensing result obtained from the illuminance sensor (S741). The reference illuminance value may correspond to a reference value for the projector to determine whether the illumination environment is the darkroom environment or the brightroom environment by sensing external illuminance.

The projector may adjust the amount of light output from the projector based on the image-capture data obtained from the image sensor when illuminance is less than the reference illuminance value (S742). As described above, even when the external illumination is disposed around the projector, the projector may not sense illuminance due to the direction and position of the external illumination and may determine illuminance to be less than the reference illuminance value. In this case, the projector may identify the change amount of an image due to the illumination based on the image-capture data obtained from the image sensor and may adjust the amount of light output from the projector based on an identification result.

The projector may adjust the amount of light output from the projector based on illuminance sensed by the illuminance sensor and the image-capture data obtained from the image sensor when illuminance is equal to or greater than the reference illuminance value (S743). The projector may adjust the amount of light output from the projector based on the sensed illuminance when the external illumination is disposed to allow the projector to sense illuminance.

However, when the external illumination is disposed at a position in which light stronger than illuminance sensed by the projector is projected onto the image projected onto the projection surface, the image is not capable of resolving an influence from the external illumination even when the projector adjusts an amount of light output from the projector based on the sensed illuminance. In this case, after adjusting the amount of light output from the projector based on the sensed illuminance, the projector may re-adjust the amount of light output from the projector based on the image-capture data obtained from the image sensor.

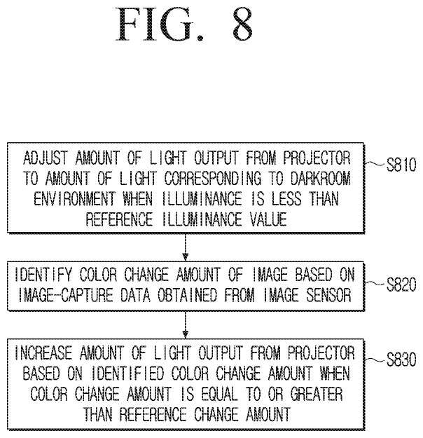

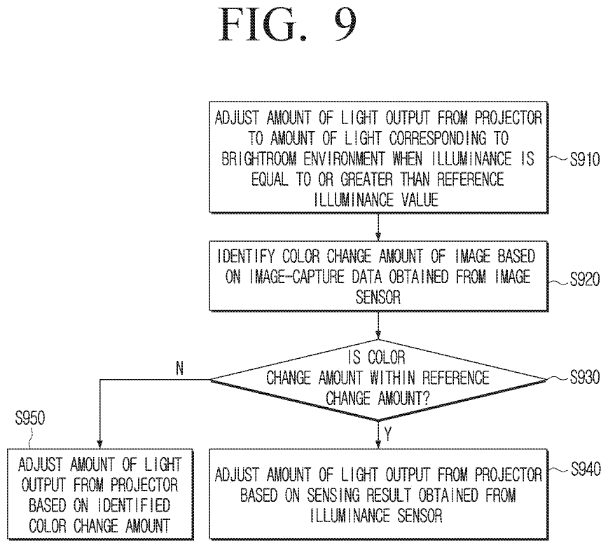

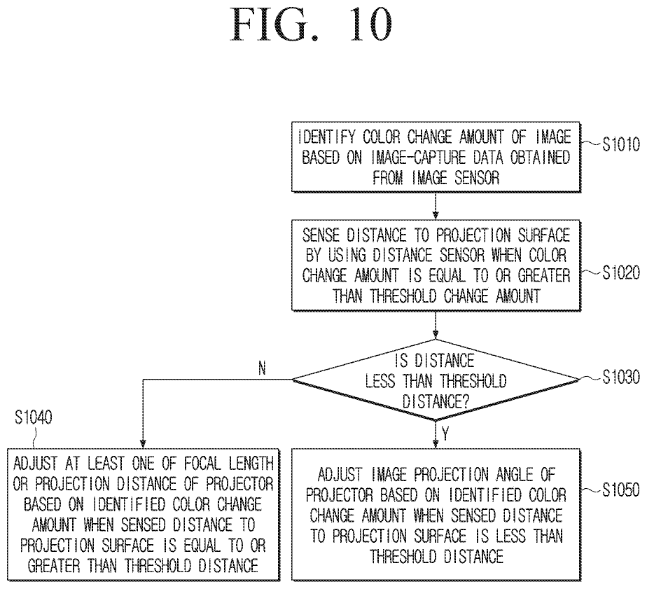

Referring to FIG. 8, the projector may adjust the amount of light output from the projector to the amount of light corresponding to the darkroom environment when illuminance is less than the reference illuminance value (S810). The projector may adjust the amount of light output from the projector based on the sensed illuminance. Accordingly, the projector may be unable to adjust the amount of light or may adjust the amount of light to the minimum output when illuminance is sensed to be less than the reference illuminance value.

Accordingly, the projector according to the present disclosure may predetermine the amount of light corresponding to the darkroom environment and store the predetermined amount of light in the memory, and may adjust an amount of light output from the projector to the predetermined amount of light corresponding to the darkroom environment when illuminance is sensed to be less than the reference illuminance value.

When the projector does not recognize illuminance or the external illumination is disposed in a direction or at a position in which light is projected onto the projection surface although illuminance is sensed to be less than the reference illuminance value, the projector may adjust an amount of light to the amount of light corresponding to the darkroom environment, and accordingly, the projector is unable to resolve an influence from the external illumination projected onto the projection surface.

In this case, the projector may identify the color change amount of the image based on the image-capture data obtained from the image sensor (S820). The projector may maintain the amount of light corresponding to the darkroom environment when the color change amount is within the reference change amount, and the projector may increase the amount of light output from the projector based on the identified color change amount when the color change amount is equal to or greater than the reference change amount (S830).

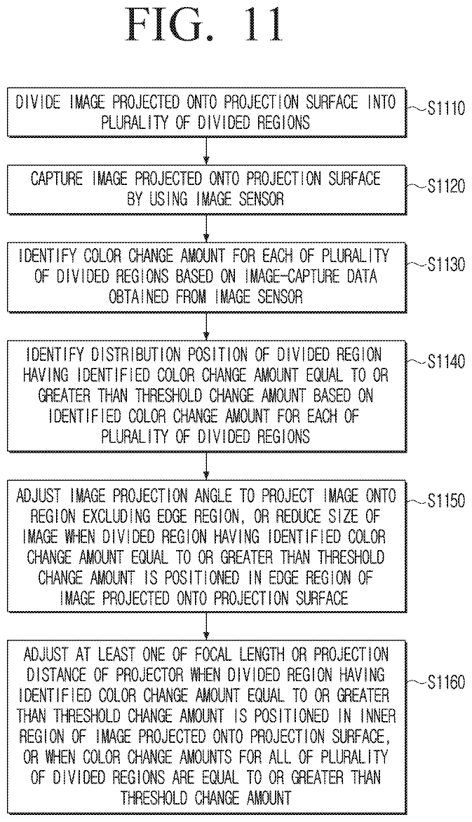

Referring to FIG. 9, the projector may adjust the amount of light output from the projector to the amount of light corresponding to the brightroom environment when illuminance is equal to or greater than the reference illuminance value (S910). The projector may predetermine the amount of light corresponding to the brightroom environment and store the predetermined amount of light in the memory, and may adjust the amount of light output from the projector to the predetermined amount of light corresponding to the brightroom environment when illuminance is sensed to be equal to or greater than the reference illuminance value.

The projector may identify the color change amount of the image based on the image-capture data obtained from the image sensor (S920). The projector may identify the color change amount of the image based on the image-capture data obtained from the image sensor in the state in which the amount of light output from the projector is adjusted to the amount of light corresponding to the brightroom environment.

The projector may determine whether the color change amount is within the reference change amount (S930).

The projector may adjust the amount of light output from the projector based on the sensing result obtained from the illuminance sensor when the color change amount is within the reference change amount (S940). When the external illumination is disposed in a direction or at a position in which the external illumination is projected onto the projector and the projection surface in the overall manner, an influence from illumination on the image may be resolved by adjusting the amount of light output from the projector based on the sensing result obtained from the illuminance sensor.

The projector may adjust the amount of light output from the projector based on the identified color change amount when the color change amount is equal to or greater than the reference change amount (S950).

When the external illumination is disposed in a direction or at a position in which light stronger than light projected onto the projector is projected onto the projection surface, an influence from illumination on the image may not be sufficiently resolved even when the projector adjusts the amount of light output from the projector based on the sensing result obtained from the illuminance sensor. In this case, in a state in which the amount of light output from the projector is adjusted to the amount of light corresponding to the brightroom environment, the projector may adjust the amount of light output from the projector based on the identified color change amount.

Alternatively, in a state in which the projector first adjusts the amount of light output from the projector based on the sensing result obtained from the illuminance sensor, the projector may readjust the amount of light output from the projector based on the identified color change amount.

Referring to FIG. 10, the projector may identify the color change amount of the image based on the image-capture data obtained from the image sensor when illuminance is equal to or greater than the reference illuminance value (S1010), and the projector may sense the distance to the projection surface by using the distance sensor when the color change amount is equal to or greater than the threshold change amount (S1020).

The color change amount of the image that is equal to or greater than the threshold change amount may indicate a state in which a color change is severe to an extent that the color change amount of the image projected onto the projection surface is not improved to fall within the reference change amount only by adjusting the amount of light output from the projector. In this case, the projector may sense the distance to the projection surface, and identify whether the sensed distance is less than the predetermined threshold distance (S1030).

The threshold distance may indicate the maximum distance to the projection surface at which the projector projects an image within the reference change amount when the projector projects an image at the maximum light output amount. Accordingly, when the distance between the projector and the projection surface is out of the threshold distance, the color change amount of the image is not capable of being reduced to be within the reference change amount only by adjusting the amount of light output from the projector.

The projector may adjust at least one of the focal length or projection distance of the projector based on the identified color change amount when the sensed distance to the projection surface is equal to or greater than the predetermined threshold distance (S1040). Alternatively, the projector may output the notification message or output the voice guidance message to reduce the distance between the projector and the projection surface to be within the threshold distance.

The projector may adjust the image projection angle of the projector based on the identified color change amount when the sensed distance to the projection surface is less than the threshold distance (S1050). When the identified color change amount is equal to or greater than the threshold change amount while the distance to the projection surface is less than the threshold distance, the projector may reduce the color change amount of the image to be within the threshold change amount by adjusting the image projection angle of the projector or by reducing the size of the image projected onto the projection surface.

When the color change amount of the image is identified to be less than the threshold change amount, the projector may readjust the amount of light output from the projector based on at least one of the sensing value obtained from the illuminance sensor and the image-capture data obtained from the image sensor.

Referring to FIG. 11, the projector may divide the image projected onto the projection surface into the plurality of divided regions (S1110). The projector may generate the coordinate information based on the image projected onto the projection surface and may divide the image into the plurality of divided regions based on the generated coordinate information.

The projector may capture the image projected onto the projection surface by using the image sensor (S1120).

The projector may identify the color change amount for each of the plurality of divided regions based on the image-capture data obtained from the image sensor (S1130). The projector may compare the original image data with the image-capture data for each of the plurality of divided regions and may identify the color change amount for each of the divided regions.

The projector may identify the distribution position of the divided region having the identified color change amount equal to or greater than the threshold change amount based on the identified color change amount for each of the plurality of divided regions (S1140). The projector may identify the position of the divided region having the color change amount equal to or greater than the threshold change amount based on the generated coordinate information, and may store the identified position in the memory.

The projector may adjust the image projection angle to project the image onto the region excluding the edge region, or reduce the size of the image when the divided region having the identified color change amount equal to or greater than the threshold change amount is positioned in the edge region of the image projected onto the projection surface (S1150).

Specifically, the projector may project the image onto the inner region excluding the edge region by controlling the projector to adjust the image projection angle or to reduce the size of the projected image when the edge region of the projected image is identified as corresponding to the state in which the color change amount of the image is not capable of being reduced to be within the reference change amount only by adjusting the amount of light output from the projector. Alternatively, the projector may output the notification message to adjust the projection direction of the image or may output the voice guidance message through the speaker.

The projector may adjust at least one of the focal length or projection distance of the projector when the divided region having the identified color change amount equal to or greater than the threshold change amount is positioned in the inner region of the image projected onto the projection surface, or when the color change amounts for all of the plurality of divided regions are equal to or greater than the threshold change amount (S1160). Alternatively, the projector may reduce the distance between the projector and the projection surface by adjusting at least one of the focal length or projection distance of the projector when the divided region having the identified color change amount equal to or greater than the threshold change amount is positioned with an unspecified distribution in the plurality of divided regions.

When the divided region having the identified color change amount equal to or greater than the threshold change amount is positioned in the inner region of the image projected onto the projection surface, or is positioned with the unspecified distribution in the plurality of divided regions, or when the color change amounts for all of the plurality of divided regions are equal to or greater than the threshold change amount, the projector may output the notification message to change the projection direction for projecting the image onto the projection surface, or may output the voice guidance message through the speaker.

When the color change amount for all of the plurality of divided regions are respectively identified to be less than the threshold change amount, the projector may readjust the amount of light output from the projector based on at least one of the sensing value obtained from the illuminance sensor and the image-capture data obtained from the image sensor, and may reduce the color change amount of the image to be within the reference change amount.

Meanwhile, according to an embodiment of the disclosure, the various embodiments described above may be implemented by software including an instruction stored on a machine-readable storage medium, the instructions being readable by a machine (e.g., a computer). The machine may be a device that invokes the stored instruction from a storage medium, may be operated based on the invoked instruction, and may include the projector according to the disclosed embodiments. When the instruction is executed by the processor, the processor may directly perform, or perform functions corresponding to the instructions by using other components under control of the processor. The instruction may include codes generated or executed by a compiler or an interpreter. The machine-readable storage medium may be provided in the form of a non-transitory storage medium. Here, the term “non-transitory” merely indicates that the storage medium is tangible without including a signal, and does not distinguish whether data are semi-permanently or temporarily stored in the storage medium.

In addition, according to an embodiment of the present disclosure, the methods according to the various embodiments described above may be provided as a computer program product. The computer program product may be traded as a product between a seller and a buyer. The computer program product may be distributed in the form of a machine-readable storage medium (e.g., a compact disc read only memory (CD-ROM)) or online through an application store (e.g., Play Store™). In the case of online distribution, at least a part of the computer program product may be temporarily stored or generated in a storage medium such as a memory of a manufacturer server, an application store server, or a relay server.

In addition, each of the components (e.g., modules or programs) according to the various embodiments described above may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before integration in the same or similar manner. Operations performed by the modules, the programs or other components according to the various embodiments may be executed in a sequential manner, a parallel manner, an iterative manner or a heuristic manner, at least some of the operations may be performed in a different order or be omitted, or other operations may be added.

As described above, the projector and the control method therefor according to the various embodiments of the present disclosure may adjust the amount of light output from the projection unit 110 based on the various external illumination environments, thereby providing the user with the image having clear image quality while reducing unnecessary power consumption.

In addition, the projector and the control method therefor according to the present disclosure may adjust the amount of light output from the projection unit 110 based on the sensing result obtained from the illuminance sensor 120 and the image-capture data obtained from the image sensor 130, thereby preventing malfunction occurring in an amount-of-light adjustment due to an influence of illuminance caused by an internal light source of the projector on the illuminance sensor 120.

Although the preferred embodiments of the present disclosure are illustrated and described as above, the present disclosure is not limited to the above-described specific embodiments, and may be variously modified by those skilled in the art to which the present disclosure pertains without departing from the scope of the present disclosure as claimed in the accompanying claims. These modifications should also be understood to fall within the spirit of the present disclosure.

What is claimed is:

1. A projector comprising:
a projection unit to project an image;
an illuminance sensor configured to sense illuminance;
an image sensor configured to capture the projected image;
a memory to store a reference illuminance value; and
a processor,
wherein the processor is configured to:
control the projection unit to project the image onto a projection surface;
adjust an amount of light output from the projection unit based on image-capture data related to the captured image obtained from the image sensor based on a sensed illuminance value of the sensed illuminance being less than the reference illuminance value; and
adjust an amount of light output from the projection unit based on the sensed illuminance obtained from the illuminance sensor and the image-capture data obtained from the image sensor based on the sense illuminance value being greater than or equal to the reference illuminance value.

2. The projector as claimed in claim 1, wherein the memory further stores a reference change amount and darkroom environment information, and
the processor is further configured to:
adjust the amount of light output from the projection unit to an amount of light corresponding to the darkroom environment information in a state in which the sensed illuminance value is less than the reference illuminance value;
identify a color change amount of the image based on the image-capture data obtained from the image sensor; and
increase the amount of light output from the projection unit based on the color change amount being equal to or greater than the reference change amount.

3. The projector as claimed in claim 1, wherein the memory further stores a reference change amount, and brightroom environment information and
the processor is further configured to:
adjust the amount of light output from the projection unit to an amount of light corresponding to the brightroom environment information based on the sensed illuminance value being equal to or greater than the reference illuminance value;
identify a color change amount of the image based on the image-capture data obtained from the image sensor; and
adjust the amount of light output from the projection unit based on the sensed illuminance obtained from the illuminance sensor based on the color change amount being within the reference change amount.

4. The projector as claimed in claim 3, wherein the processor is further configured to
adjust the amount of light output from the projection unit based on the image-capture data obtained from the image sensor based on the color change amount being equal to or greater than the reference change amount.

5. The projector as claimed in claim 1, further comprising
a distance sensor configured to sense a distance from the projector to the projection surface,
wherein the memory is further configured to store a threshold change amount, and
the processor is further configured to:
identify a color change amount of the image based on the image-capture data obtained from the image sensor;
identify the distance to the projection surface based on the sensed distance obtained from the distance sensor based on the color change amount being equal to or greater than the threshold change amount; and
adjust at least one of an image projection angle, a focal length, and a projection distance of the projection unit based on the identified distance.

6. The projector as claimed in claim 5, wherein the memory is further configured to store a threshold distance, and
the processor is further configured to:
adjust the image projection angle of the projection unit based on the identified color change amount based on the distance being less than the threshold distance, and
adjust at least one of the focal length and the projection distance of the projection unit based on the identified color change amount based on the distance being equal to or greater than the threshold distance.

7. The projector as claimed in claim 1, wherein the memory is further configured to store a threshold change amount, and
the processor is further configured to:
divide the image projected onto the projection surface into a plurality of divided regions;
control the image sensor to capture the image projected onto the projection surface; and
identify a color change amount for each of the plurality of divided regions based on the image-capture data obtained from the image sensor; and
adjust at least one of an image projection angle, a focal length, and a projection distance of the projection unit based on a distribution position of a divided region having an identified color change amount equal to or greater than the threshold change amount.

8. The projector as claimed in claim 7, wherein the processor is further configured to:
based on the divided region having the identified color change amount being equal to or greater than the threshold change amount being positioned in an edge region of the image projected onto the projection surface, control the projection unit to adjust an image projection angle of the projection unit to project the image onto a region excluding the edge region, reduce a size of the image projected onto the region excluding the edge region; based on the divided region having the identified color change amount equal to or greater than the threshold change amount being positioned in an inner region of the image projected onto the projection surface, adjust at least one of the focal length and the projection distance of the projection unit; and
based on color change amounts for all of the plurality of divided regions being equal to or greater than the threshold change amount, adjust the at least one of the focal length and the projection distance of the projection unit.

9. A control method for a projector, the method comprising:
projecting an image onto a projection surface;
sensing illuminance by using an illuminance sensor of the projector;
capturing the image projected onto the projection surface by using an image sensor of the projector; and
adjusting an amount of light output from the projector based on at least one of the sensed illuminance obtained from the illuminance sensor and image-capture data related to the captured image obtained from the image sensor,
wherein the adjusting of the amount of light output from the projector includes:
adjusting the amount of light output from the projector based on the image-capture data obtained from the image sensor based on a sensed illuminance value of the sensed illuminance being less than a reference illuminance value, and
adjusting the amount of light output from the projector based on the illuminance sensed by the illuminance sensor and the image-capture data obtained from the image sensor based on the sensed illuminance value being equal to or greater than the reference illuminance value.

10. The method as claimed in claim 9, wherein the adjusting of the amount of light output from the projector based on the image-capture data obtained from the image sensor based on the sensed illuminance value being less than the reference illuminance value includes:
adjusting the amount of light output from the projector to an amount of light corresponding to darkroom environment information based on the sensed illuminance value being less than the reference illuminance value;
identifying a color change amount of the image based on the image-capture data obtained from the image sensor; and
increasing the amount of light output from the projector based on the identified color change amount based on the color change amount being equal to or greater than a reference change amount.

11. The method as claimed in claim 9, wherein the adjusting of the amount of light output from the projector based on the illuminance sensed by the illuminance sensor and the image-capture data obtained from the image sensor based on the sensed illuminance value being equal to or greater than the reference illuminance value includes:
adjusting the amount of light output from the projector to an amount of light corresponding to brightroom environment information based on the sensed illuminance value being equal to or greater than the reference illuminance value;
identifying a color change amount of the image based on image-capture data obtained from the image sensor; and
adjusting the amount of light output from the projector based on the sensed illuminance obtained from the illuminance sensor based on the color change amount being within a reference change amount.

12. The method as claimed in claim 11, wherein the adjusting of the amount of light output from the projector based on the illuminance sensed by the illuminance sensor and the image-capture data obtained from the image sensor based on the sensed illuminance value being equal to or greater than the reference illuminance value further includes
adjusting the amount of light output from the projector based on the identified color change amount based on the color change amount being equal to or greater than the reference change amount.

13. The method as claimed in claim 9, wherein the adjusting of the amount of light output from the projector based on the illuminance sensed by the illuminance sensor and the image-capture data obtained from the image sensor based on illuminance being equal to or greater than the reference illuminance value includes:
identifying a color change amount of the image based on the image-capture data obtained from the image sensor;
sensing a distance to the projection surface by using a distance sensor of the projector based on the color change amount being equal to or greater than a threshold change amount;
adjusting at least one of a focal length and a projection distance of the projector based on the identified color change amount based on the sensed distance to the projection surface being equal to or greater than a threshold distance, and
adjusting an image projection angle of the projector based on the identified color change amount based on the sensed distance to the projection surface being less than the threshold distance.

14. The method as claimed in claim 9, further comprising:
dividing the image projected onto the projection surface into a plurality of divided regions;
capturing the image projected onto the projection surface by using the image sensor;
identifying a color change amount for each of the plurality of divided regions based on the image-capture data obtained from the image sensor;
identifying a distribution position of a divided region having an identified color change amount equal to or greater than a threshold change amount based on the identified color change amount for each of the plurality of divided regions;
based on the divided region having the identified color change amount equal to or greater than the threshold change amount being positioned in an edge region of the image projected onto the projection surface, controlling the projector to adjust an image projection angle to project the image onto a region excluding the edge region, or to reduce a size of the image projected onto the region excluding the edge region;
based on the divided region having the identified color change amount equal to or greater than the threshold change amount being positioned in an inner region of the image projected onto the projection surface, adjusting at least one of a focal length and a projection distance of the projector; and
based on color change amounts for all of the plurality of divided regions being equal to or greater than the threshold change amount, adjusting the at least one of the focal length and the projection distance of the projector.

15. A computer-readable recording medium storing a program for executing a control method for a projector, wherein the method includes:
projecting an image onto a projection surface;
sensing illuminance by using an illuminance sensor;
capturing the image projected onto the projection surface by using an image sensor of the projector;
adjusting an amount of light output from the projector based on image-capture data related to the capture image obtained from the image sensor based on a sensed illuminance value of the sensed illuminance being less than a reference illuminance value; and
adjusting an amount of light output from the projector based on the illuminance sensed by the illuminance sensor and the image-capture data obtained from the image sensor based on the sensed illuminance value being equal to or greater than the reference illuminance value.
